(19) United States
(12) Patent Application Publication
(10) Pub. No.: US 2019/0370847 A1
(43) Pub. Date: Dec. 5, 2019

(54) METHOD AND SYSTEMS RELATING TO THE USE OF BLOCKCHAIN AND SELF-SOVEREIGN IDENTITY FOR GIFT CARDS, REWARDS, AND INCENTIVES PROGRAMS

(71) Applicant: Sal Khan, Ottawa (CA)

(72) Inventor: Sal Khan, Ottawa (CA)

(21) Appl. No.: 16/391,259

(22) Filed: Apr. 22, 2019

Related U.S. Application Data
(63) Continuation of application No. 62/677,695, filed on May 30, 2018.

(51) Int. Cl. G06Q 30/02; H04L 9/06; G06Q 20/32; G06Q 20/20; G06Q 20/36

(52) U.S. Cl. CPC G06Q 30/0233; H04L 9/0637; G06Q 20/3223; G06Q 20/3674; G06Q 30/0222; G06Q 30/0236; G06Q 20/204

(57) ABSTRACT

Current technologies employed by rewards, gift card and e-coupon (incentive programs) have proven to be susceptible to fraud and high program costs. Of paramount concern is the current ease with which criminals can ‘steal’ value belonging to legitimate incentive holders from retailers and service providers. The inventors, through embodiments of this invention, address these issues by using a fixed-value cryptographic token, immutable distributed ledger technology, Self-Sovereign Identity, and strong authentication integrated into a digital wallet. The tokens, as embodied in the invention, are variable, redeemable, transferable, exchangeable, and multi-use. They can offer discounts, instant rewards, and other incentives. With ownership of the tokens powered by Self-Sovereign Identity, the tokens, and the distributed ledger ensure that incentives are delivered to, and redeemed by the intended recipient. One of the invention claims describes how the system and tokens are used by retailers and manufacturers to provide rewards to consumers in exchange for completing surveys, offering preferences, and providing transaction data.

### FIELD OF THE INVENTION

This patent application relates to reward and incentive programs and more particularly to methods and systems for providing secure transferable rewards and incentives exploiting techniques such as blockchain, cryptography, and cryptocurrencies to provide transferrable, tradeable, and variable value rewards and incentives.

### BACKGROUND OF THE INVENTION

Cryptocurrencies are digital currencies in which encryption techniques are used to regulate the generation of units of currency and verify the transfer of funds, operating independently of a central bank. However, customers, businesses, enterprises, etc. today exploit a number of different reward programs to incentivize loyalty to a brand, retailer, service provider etc. Cryptocurrencies do not provide such rewards.

Accordingly, it would be beneficial to provide users of cryptocurrencies with mechanisms of acquiring, transferring, and using cryptographic rewards.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to reward and incentive programs and more particularly to methods and systems for providing secure transferable rewards and incentives exploiting techniques such as blockchain, cryptography, and cryptocurrencies to provide transferrable, tradeable, and variable value rewards and incentives.

In accordance with an embodiment of the invention there is provided a method comprising storing a transaction employing a token within a digital immutable ledger.

In accordance with an embodiment of the invention there is provided a method comprising:
performing a transaction between an individual and at least one of a retailer and a service provider; establishing a reward in dependence upon the transaction;
providing to a digital store associated with the individual the reward in a digital cryptographic currency; and
posting to a digital immutable ledger an addition to the ledger relating to the transaction.

In accordance with an embodiment of the invention there is provided entry within a distributed immutable ledger, comprising
a first portion encrypted with a first encryption key identifying another entry in the distributed immutable ledger;
a second portion encrypted with a second encryption key identifying an owner of the entry within the distributed immutable ledger; and
a third portion encrypted with a third encryption key defining a value associated with the entry; wherein
the value relates to a cryptographic currency.

In accordance with an embodiment of the invention there is provided a virtual token relating to a cryptographic currency, wherein
the token has associated within it an attribute not related to a value of the token; and
the attribute comprises at least one of a characteristic of a plurality of characteristics, a benefit of a plurality of benefits, a right of a plurality of rights, an obligation of a plurality of obligations, and a limitation of a plurality of limitations.

In accordance with an embodiment of the invention there is provided a method comprising storing a transaction employing a token within one or more digital immutable ledgers.

In accordance with an embodiment of the invention there is provided a method comprising:
storing a transaction employing a token within one or more digital immutable ledgers, wherein
a first individual engages in a transaction to purchase goods or services from a third party that is at least one of a retail vendor, wholesale vendor, retail merchandiser, wholesale merchandiser, retail service provider, wholesale service provider, a second individual;
upon the first individual and third party agreeing that the terms of exchange of the transaction have been satisfied, one or more records of the transaction is prepared containing at least one of:
   identity information associated with the first individual;
   identity information associated with the third party;
   a description of the goods or services obtained by the first individual;
   a description of the remuneration offered the third party by the first individual;
   a description of the method of payment involved in delivering that remuneration;
   a reward amount, to be delivered in the form of a virtual currency represented by a cryptographic token by the third party to the first individual.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment supporting embodiments of the invention;

FIG. 2 depicts an electronic device supporting embodiments of the invention;

FIG. 3 depicts an exemplary transaction flow relating to rewards and incentives according to an embodiment of the invention;

FIG. 4 depicts an exemplary transaction flow relating to a digital economy exploiting rewards and incentives according to an embodiment of the invention; and

FIG. 5 depicts an exemplary rewards and incentive program between a customer and a vendor/service provider exploiting rewards and incentives according to embodiments of the invention.

### DETAILED DESCRIPTION

The present description is directed to reward and incentive programs and more particularly to methods and systems for providing secure transferable rewards and incentives exploiting techniques such as blockchain, cryptography, and cryptocurrencies to provide transferrable, tradeable, and variable value rewards and incentives.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and /or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors. The wearable devices and/or wearable sensors may include, but not be limited to, devices that can stimulate and/or measure parameters that are designed to fit on or near the perineum, anal area, vagina, clitoral area, and nipples.

“Quantified self” as used herein may refer to, but is not limited to, the acquisition and storage of data relating to a user's daily life in terms of inputs (e.g. food consumed, quality of surrounding air), states (e.g. mood, arousal, blood oxygen levels), and performance (mental and physical). Acquisition of data may be combine wearable sensors (EEG, ECG, video, etc.) and wearable computing together with audio, visual, audiovisual and text based content generated by the user.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, retinal patterns, iris patterns, eye vein patterns and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

A “rewards program”, “loyalty program”, or “incentive program” as used herein may refer to, but not be limited to, a structured marketing strategy designed by merchants, employers, organizations, users etc. to encourage customers to continue to shop at or use the services of businesses associated with each program. These programs exist covering most types of commerce, each one having varying features and rewards-schemes. Such programs may be so-called business-to-consumer (B2C) or business-to-business (B2B) and may relate to one or more of physical transactions, electronic transactions, mail order, physical retailing, online retailing, etc.

A “blockchain” (originally block chain) as used herein may refer to, but not be limited to, a continuously growing list of records, called blocks, which are linked and secured using cryptography. Each block typically contains a cryptographic hash of one or more other blocks in the chain, a timestamp and transaction data. By design, a blockchain is inherently resistant to modification of the data and provides for an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without the alteration of all subsequent blocks, which requires collusion of the network majority. Blockchains are secure by design and exemplify a distributed computing system with high Byzantine fault tolerance. Decentralized consensus has therefore been achieved with a blockchain which makes them suitable for the recording of events, medical records, and other records management activities, such as identity management, financial transaction processing, documenting provenance, food traceability, voting, etc. Within embodiments of the invention the cryptographic hash may also include a pointer (and possibly a hash) of the address of the next block in the chain.

A “distributed ledger” as used herein may refer to, but not be limited to, a is a database that is consensually shared and synchronized across one or more networks spread across multiple sites, institutions and/or geographies. It allows transactions to have public “witnesses,” thereby making a cyberattack more difficult. The participant at each node of the network can access the recordings shared across that network and can own an identical copy of it. Further, any changes or additions made to the ledger are reflected and copied to all participants quickly, usually within seconds or minutes. Underlying a distributed ledger technology are blockchains.

A “cryptographic currency” or crypto currency) as used herein may refer to, but not be limited to, a digital asset designed to work as a medium of exchange that uses cryptography to secure its transactions, to control the creation of additional units, and to verify the transfer of assets. Cryptocurrencies are a type of digital currencies, alternative currencies and virtual currencies. Cryptocurrencies use decentralized control as opposed to centralized electronic money and central banking systems. The decentralized control of each cryptocurrency works through a blockchain, which is a public transaction database, functioning as a distributed ledger.

A “Retro” as used herein may refer to, but not be limited to, a “cryptographic token” or “asset based token” which is issued by a party onto a blockchain or other digital immutable ledger for later redemption. They are the digital equivalent to a physical asset and are claims on an underlying asset which may be claimed from a specific issuer. Transactions relating to the Retro are recorded on the blockchain and in order to claim the underlying asset the current “owner” sends the token to the issuer who then sends the underlying asset. Alternatively, the Retro is exchanged for another asset and the subsequent transfer to the provider of another asset then noted within the blockchain. A Retro is therefore a cryptocurrency established with respect to a reward program. A Retro according to embodiments of the invention has one or attributes attached to it, each attribute being at least one of a characteristic, a benefit, a right, an obligation and a limitation, wherein different tokens can have different benefits, rights, obligations, and limitations attached to them. For simplicity within this description in respect of embodiments of the invention Retros having different characteristics (including, but not limited to, corporate or product brands), benefits, rights, obligations and limitations are referred to as being different “colours” and any specific colours identified within the description are merely examples for ease of reference to the reader. Within embodiments of the invention one or more of these characteristics, benefits, rights, obligations and limitations may be fixed for a Retro once issued to a user (i.e. its colour is fixed) or they may be variable (i.e. its colour may change) post-issuance. Within other embodiments of the invention the one or more of these characteristics, benefits, rights, obligations and limitations may be undefined at a specific point subsequent to initial issuance, i.e. the Retro has no colour which is commonly referred to as white, and established subsequently, i.e. its colour defined, such as where an issuer issues to a service provider white Retros which are then provided to customers as rewards for example wherein the service provider then defines the colour of the Retro.

“Self-Sovereign Identity” as used herein may refer to, but not be limited to, an identity which is created and managed by the individual, and enables them to maintain their digital identities independent from residence, national electronic identity (eID) infrastructure and market-dominating service providers. According to Allen (2016, “The Path to Self-Sovereign Identities”) a self-sovereign identity can be characterized by the ten commandments. These being existence of the identity of a person independent of identity administrators or providers, the person being in control of their digital identities, the person having full access to their own data, systems and algorithms are transparent, digital identities are persistent, digital identities being portable, digital identities being interoperable, data economy being enforced, and the rights of the person being protected.

Accordingly, a Retro may within its cryptographically defined content include reference to its different characteristics, benefits, rights, obligations and limitations. In some embodiments this may be via a colour model such as CIE XYZ colour space, RGB, HSV, HSL, and CMYK for example or an alternate identification scheme wherein vendors register their colour with a centralized Retro issuing authority together with its different characteristics, benefits, rights, obligations and limitations.

According to embodiments of the invention a Retro may be a divisible token or an indivisible token. For example, within an embodiment of the invention a Retro may be divisible, and the divisible portions referred to as “Grains.” The extent to which a Retro is divisible may be set with respect to all Retros, specific Retro tokens, certain colours of Retro etc. For example, a Grain may represent as little as little as 0.00000001 (10−8) of a Retro and transactions or activities at this level are recordable within the blockchain or other distributed ledger. Within another embodiment the Retro may be only divided into 100 grains so that the Retros/Grains resemble dollars and cents to the users.

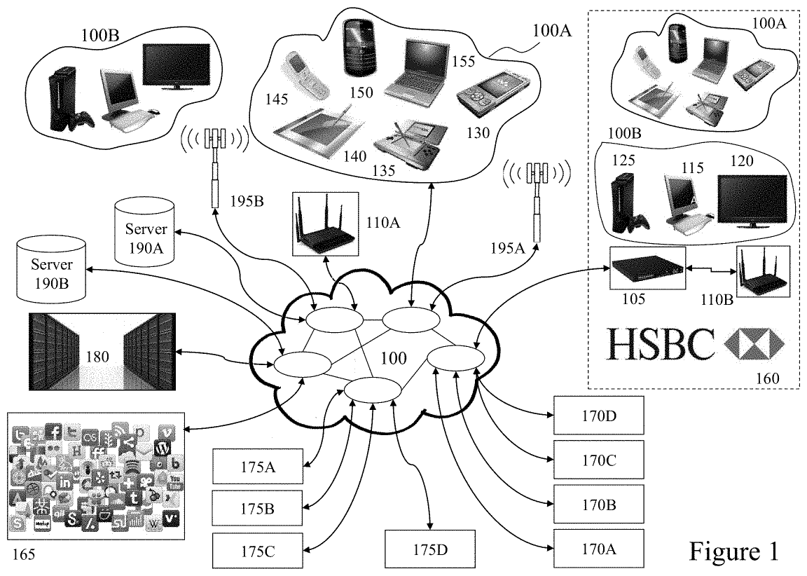

Referring to FIG. 1 there is depicted a network environment within which embodiments of the invention may be employed supporting devices, systems, applications, and platforms (DSAPs) according to embodiments of the invention. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, such as Adam & Eve™ for example, within which other first and second user groups 100A and 100B are disposed. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 100, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are:
Social Networks (SOCNETS) 165;
Original Equipment Manufacturer (OEM) 170A, for example Ford™, Apple™, Hewlett-Packard™, etc.;
Manufacturer 170B, for example Procter and Gamble™, PepsiCo, Nike™, Anheuser-Busch™ etc.;
Retailer 170C, for example Starbucks™, Walmart™, Walgreens™, Tesco™, etc.;
Online retailer 170D, for example Amazon™, Alibaba™, Wish™, etc.;
Website 175A, for example online portals for OEMs 170A, manufacturers 170B, retailers 170C, service providers 175B, third party service providers 175C, and enterprises 175D;
Service provider 175B, for example AT&T™, Verizon™, DoCoMo™, Comcast™, Consolidated Edison™;
Third party service provider 175C, for example HSBC™, JP Morgan Chase™, Mastercard™, Visa™, etc.;
Enterprise 175D, for example IBM™, Adobe Systems™, Siemens™, etc.; and
First and second servers 190A and 190B together with others, not shown for clarity.

Accordingly, a user employing one or more DSAPs may interact with one or more such providers, enterprises, service providers, retailers, third parties etc. and other users. First and second servers 190A and 190B may host according to embodiments of the inventions multiple services associated with a provider of adult device systems, applications, and platforms (DSAPs); a provider of a SOCNET or Social Media (SOME) exploiting DSAP features; a provider of a SOCNET and/or SOME not exploiting DSAP features; a provider of services to PEDS and/or FEDS; a provider of one or more aspects of wired and/or wireless communications; an Enterprise 160 exploiting DSAP features; license databases; content databases; image databases; content libraries; customer databases; websites; and software applications for download to or access by FEDs and/or PEDs exploiting and/or hosting DSAP features. First and second primary content servers 190A and 190B may also host for example other Internet services such as a search engine, financial services, third party applications and other Internet based services.

Accordingly, a user may exploit a PED and/or FED within an Enterprise 1060, for example, and access one of the first or second primary content servers 190A and 190B respectively to perform an operation such as accessing/downloading an application which provides DSAP features according to embodiments of the invention; execute an application already installed providing DSAP features; execute a web based application providing DSAP features; or access content Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

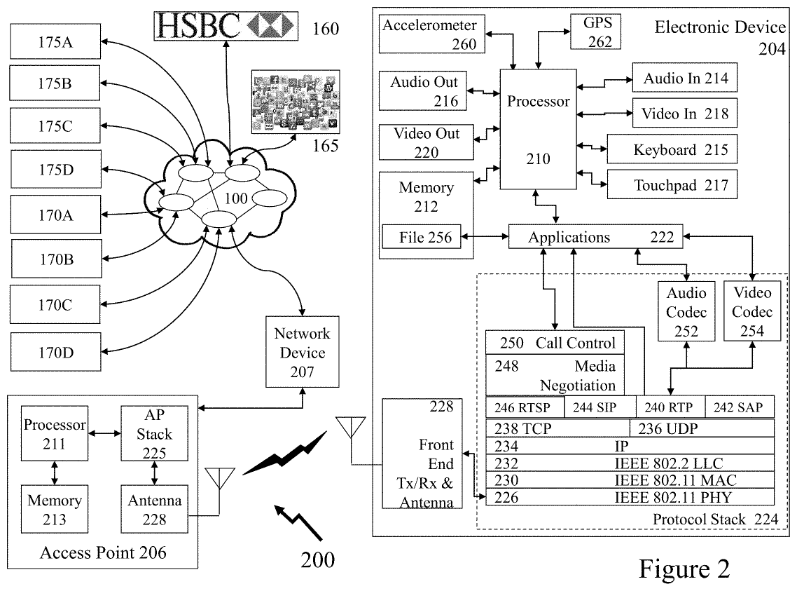

Now referring to FIG. 2 there is depicted an electronic device 204 and network access point 207 supporting DSAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated.

Also connected to the network 100 are:
Social Networks (SOCNETS) 165;
Original Equipment Manufacturer (OEM) 170A, for example Ford™, Apple™, Hewlett-Packard™, etc.;
Manufacturer 170B, for example Procter and Gamble™, PepsiCo, Nike™, Anheuser-Busch™ etc.;
Retailer 170C, for example Starbucks™, Walmart™, Walgreens™, Tesco™, etc.;
Online retailer 170D, for example Amazon™, Alibaba™, Wish™, etc.;
Website 175A, for example online portals for OEMs 170A, manufacturers 170B, retailers 170C, service providers 175B, third party service providers 175C, and enterprises 175D;
Service provider 175B, for example AT&T™, Verizon™, DoCoMo™, Comcast™, Consolidated Edison™;
Third party service provider 175C, for example HSBC™, JP Morgan Chase™, Mastercard™, Visa™, etc.;
Enterprise 175D, for example IBM™, Adobe Systems™, Siemens™, etc.; and
First and second servers 190A and 190B together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Tx/Rx & Antenna Circuits 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238. Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206.

Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230. It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted is ASsociated DEVice (ASDEV) 270 which is coupled to the electronic device 204 through a wireless interface between Antenna 272 and Tx/Rx & Antenna Circuits 228 wherein the electronic device 204 may support, for example, a national wireless standard such as GSM together with one or more local and/or personal area wireless protocols such as IEEE 802.11 a/b/g Wi-Fi, IEEE 802.16 WiMAX, and IEEE 802.15 Bluetooth for example. The Antenna 272 is connected to Processor 274 and therein to Memory 276, Drivers 278, and Features 280. Accordingly, the ASDEV 270 may operate as standalone device with factory installed control routines accessed through an interface on the ASDEV 270, not shown for clarity, or through an application in execution upon the electronic device 204. Subsequently, as described below one or more of these control routines may be modified, amended, deleted etc. whilst other new control routines may be created, acquired, installed etc.

Accordingly, it would be evident to one skilled the art that the ASDEV 270 with associated electronic device 204 may accordingly download original software and/or revisions for a variety of functions supported by the drivers 278 and/or features 280. In some embodiments of the invention the functions may not be implemented within the original as sold ASDEV 270 and are only activated through a software/firmware revision and/or upgrade either discretely or in combination with a subscription or subscription upgrade for example.

Within the prior art rewards programs, loyalty programs, or incentive programs are structured marketing strategies designed by merchants to encourage customers to continue to shop at or use the services of businesses associated with each program. Examples may include, but are not limited to, Air Miles™, Discover™, Starbucks™, HSBC™, etc. These programs exist covering most types of commerce, each one having varying features and rewards-schemes. Historically, in marketing generally and in retailing more specifically, a loyalty card, rewards card, points card, advantage card, or club card was a plastic or paper card, visually similar to a credit card, debit card, or digital card that identifies the card holder as a participant in a loyalty program. Such cards are now increasingly replaced by software applications (commonly referred to as “apps”) which are stored and accessed upon a user's PED. Physically cards typically have a barcode, magnetic stripe or radiofrequency identity (RFID) chip that can be easily scanned, although some are chip cards or proximity cards. Small keyring cards (also known as key tags) which serve as key fobs are also employed bringing convenience in carrying and ease of access. Electronic “cards” are typically presented as barcodes upon the display of a user's PED which is then scanned at a Point-of-Sale (PoS) terminal although RFID or near-field communications (NFC) may also be employed.

By presenting such a card, purchasers typically earn the right either to a discount on the current purchase, or to an allotment of points that they can use for future purchases, or both. Accordingly, the card is the visible means of implementing a type of what economists call a two-part tariff. Application forms for cards usually entail agreements by the retailer concerning customer privacy, typically non-disclosure (by the retailer) of non-aggregate data about customers. The retailer exploits the aggregate data internally (and sometimes externally) as part of its marketing research. Over time the data can reveal, for example, a given customer's favorite brand of beer, or whether he or she is a vegetarian. Where a customer has provided sufficient identifying information, the loyalty card may also be used to access such information to expedite verification during receipt of cheques or dispensing medical prescription preparations, or for other membership privileges (e.g., access to a club lounge in airports, using a frequent-flyer card etc.).

Accordingly, a loyalty program provides the customer with a program specific virtual currency, one with unidirectional cash flow, since reward points can be exchanged into a good or service but not into cash. Some programs such as those with retailers, e.g. Starbucks™, allow the user to acquire this virtual currency through transactions with the retailer where the “card” is presented or employed as part of the transaction. Some programs such as Air Miles™ allow the user to acquire this virtual currency through transactions with multiple retailers where the “card” is presented or employed as part of the transaction but the redemption is limited to one type of product, flights. Some service provider programs, such as HSBC™, Mastercard™ etc. for example, allow the user to acquire this virtual currency through transactions with multiple physical and online retailers provided the transaction exploits a financial instrument of the service provider, e.g. HSBC™ Mastercard™, and the customer may redeem through the service provider in different forms such as product purchases, gift card purchases, cash paid onto their credit card bill etc.

These concepts in business-to-customer (B2C) commerce transfer to business-to-business (B2B) loyalty programs reward a business for repeat purchases of goods and services from a supplier. However, a business may also exploit service provider rewards programs such as Air Miles™, HSBC™, etc. by exploiting the rewards associated with using the financial instrument with respect to their business purchases etc. Such concepts may also be extended to employer to employee schemes etc.

However, a common feature to all is that the “virtual currency” of the program is that they are redeemable through only the retailer/service provider offering the program or a set of retailers offering a common product such as with Air Miles™. Further, the rate at which the owner of the reward program account earns rewards and can spend rewards are at rates defined by the retailer, service provider etc. For example, a consumer may accumulate one reward point for a predetermined financial value, e.g. 15 points per $1 spent, and redeem 1,000 points for $1 so that the effective return to the customer is a rate of 1.5% but the redemption can only be undertaken at the retailer's stores and for a minimum 10,000 points, for example. Accordingly, many customers find the limits of such reward programs a significant limitation. Such limits include limited options for redemption, e.g. fixed rewards established by retailer, the inability to transfer rewards to another individual, combine rewards between multiple customers to purchase a higher value product, or inability to exploit rewards outside the program they were acquired in.

One option to circumvent this is the concept within U.S. Patent Application 2010/0,250,360 entitled “Trading Platform for the Redemption of Promotional Currency from Multiple Loyalty Programs” wherein a trading platform allows a registered user to acquire a product offered through another reward program by establishing an agreement with another user who is a member of the reward program the registered user seeks to acquire from. Accordingly, each user purchases from their program and exchanges with the other user. However, this may require the user to redeem substantially more rewards “points” than they might wish in order to incentivize the other user to be part of the “trade.” Further, the user is still restricted to the products/services of each program. Further, the rewards, points etc. even within this system are not transferrable from one owner to another. This system still requires that the two parties each exploit their rewards within their own program and that they are shipped to the other party.

However, within embodiments of the invention one or more rewards programs can exploit “tokens”, particularly cryptographically defined tokens, which within the following description are referred to are referred to as “Retros.” For example, a Retro may be defined by an identity such as “1HieAFgpQdrVLN8GPFMfG8yMcDxDsrXiLN.” Within embodiments of the invention a Retro according to embodiments of the invention has the following attributes:
A Retro is a cryptographically defined “I Owe You” (abbreviated as IOU, which refers to a document or electronic document acknowledging a debt) and is accordingly an asset;
A Retro has characteristics, benefits, rights, obligations and limitations attached to it and different tokens can have different benefits, rights, obligations, and limitations attached to them;
A Retro can deliver increasing or decreasing amounts of value rather than being fixed;
A Retro can deliver fluctuating amounts of value rather than being fixed; and

A Retro can exploit “network effect” for growth.

Within embodiments of the invention a Retro or token for a reward program is differentiated from prior art rewards by exploiting a cryptographic token to store and record the reward acquired by a customer to a reward program. Accordingly, all transactions related to retro crypto-currency and any/all of its variants (i.e. “coloured tokens” as described below) are tracked using “RetroChains” which are asset based chains. Accordingly, the token transactions are recorded on a digital immutable ledger. Accordingly, the digital immutable ledger may include, but not be limited to, a blockchain, a collection of asset chains, or a digital immutable ledger data store.

Users store and employ their Retros through a transaction involving a “RetroWallet” which is digital application providing a representation of the Retros currently possessed by a user, a means for a user to acquire Retros, and a means for the user to spend or transfer their Retros. Through the RetroWallet Retro owners can store and employ their Retros through transactions that involve Retro rewards in any form (either a consumer being given some sort of Retro as a reward, or a consumer spending accrued Retros to pay for a transaction) which accordingly result in the digital immutable ledger, hereinafter referred to as “RetroChain”, recording the transfer of the Retros. With a RetroWallet a user will always be able to monitor their balance(s) of Retros from within the RetroWallet. As will become evident within the following description the user may possess one or more “variant forms” of Retros as Retros may through the benefits, rights, obligations and limitations attached to them have different forms. For example, one variant form may provide Retros, i.e. tokens, that can only be spent at a specific retailer, e.g. Starbucks™ for example, whilst another variant may provide for Retros that can be acquired from multiple vendors but are only redeemable for a specific brand of product, e.g. Coca-Cola™, whilst another may have no restrictions at all. Accordingly, the RetroWallet can display the multiple separate balances.

As noted previously, Retros have characteristics, benefits, rights, obligations, value and limitations attached to them and different Retros can have different characteristics, benefits, rights, obligations, and limitations attached to them. Amongst these is the Retro's value. Within embodiments of the invention the Retros may be acquired either at fixed value, at a variable value but constant once acquired, or a variable value which varies post-acquisition. Considering, the fixed value then Retros, as with prior art rewards programs may be acquired by a user based upon the value of the transaction they undertake with a retailer, service provider etc. at a specified rate, e.g. 1%, 1.5%, etc. Alternatively, a fixed value reward in Retros may be per transaction independent of the value of the transaction.

With respect to the user acquiring Retros at a variable value but constant once acquired this may be implemented with different schemes which may be established by retailer, by OEM of product etc. For example, the value acquired may be tiered or banded such that transactions below a certain value are at one rate, between other values at other rates, etc. or it may be calculated within tiers or bands in a similar manner to income tax such that to a first monetary value it is at a first rate, residual transaction value above the first monetary threshold is at a second rate, residual transaction value above a second monetary threshold is at a third rate, etc.

Within another embodiment of the invention the user may acquire Retros that have a variable value that is not constant once acquired. For example, the value of the Retros may be established through a process that defines a variable value to the Retros. Within an embodiment of the invention an OEM, manufacturer etc. might authorise Retros to be issued that upon redemption have a value scaled by the scaling of the company's share price since the Retros were issued. As the RetroChain defines the date of acquisition then the process is relatively straight-forward. Accordingly, if the company shares have doubled then the Retro value has doubled. However, if the company shares drop then so does the value of the Retro which may incent those owning Retros within a company to seek to ensure its share price increases by purchasing more, encouraging friends, family etc. to buy from that brand or retailer etc. Alternatively, within another embodiment of the invention the Retros issued may be traded on an exchange and the overall software solution for the Retro system automatically converts the current value of the Retro in any transaction. For example, if a vendor wants to give a Retro for every $10 spent as a reward for the purchase of a product based on the “nominal” Retro price being $1, for example, then the purchaser receives 10 Retros irrespective of the value of the Retro at that point in time. Accordingly, as the value of the Retro fluctuates on the exchange then so does the effective value of the reward given and subsequently the Retro software will automatically adjust the effective monetary value of the Retros based upon the adjustment in pricing of the Retros on the exchange at the point a user wishes to “spend” the Retros. Hence, if the user acquires Retros at a point their value is the monetary equivalent of $1 then if at the point they wish to redeem for a purchase they are worth $2 then the software performs the necessary transfer of the appropriate number of Retro based upon that monetary equivalent. Alternatively, a retailer may for example provide a Retro reward which is at a fixed value, e.g. $1 for every $20 spent then the Retro software calculates the number of Retros to be given as the reward for the purchase of that product at that point in time so irrespective of whether the Retro “price” fluctuates up or down the purchaser the user acquires the number of Retros equal to cash reward. Subsequently, the value of the Retros may similarly fluctuate up or down as they are traded upon the exchange.

Amongst the different characteristics, benefits, rights, obligations, and limitations attached to Retro's is their transferability. Accordingly, Retros may be transferable and/or non-transferable. For example, a retailer may dedicate Retro's given as rewards as being non-transferrable, i.e. usable only at the retailer where such tokens may be considered as vendor specific tokens. Alternatively, a retailer for example, may dedicate Retro's given as rewards as transferable and which can therefore be used anywhere Retros are used and accepted, including at an Exchange.

Amongst the different characteristics, benefits, rights, obligations, and limitations attached to Retro's is a discount. A Retro can be defined to show a discount, e.g., 10% off, 20% off, 40% off etc. Accordingly, when a Retro with a discount characteristic is used in a transaction its value based on the transaction value is calculated and a reward given based on a vendor specific percentage of the value of the transaction.

Amongst the different characteristics, benefits, rights, obligations, and limitations attached to Retro's is the aspect of Reward Bonus Premiums (RBPs). For example, within some embodiments of the invention Retros can be employed within an instant reward program (IRP) with bonus premiums established on the consumer's purchasing behavior. An IRP represents a short-term program that rewards consumers instantly with small premiums per fixed spending, where these premiums are part of a larger set of collectibles. For example, Retros may be issued as part of an IRP that promotes specific brands with an extra reward, for example a labeled bonus reward. Such labeled bonus rewards would allow consumers to acquire additional Retros by buying a specific promoted brand, which is a non-price promotion tied to the IRP. Therefore, consumers can earn Retro rewards in two ways: based on total spending and on purchases of promoted brands. The Retro can be programmed by the vendor, for example using software to offer a price discount and a Reward Bonus Premium. An RBP with respect to Retros may also be employed as an employee bonus. This software may be standalone for Retro's or it may be associated with one or more software programs and/or suites associated with an electronic payment system, financial institution, original equipment manufacturer, financial exchange, cryptocurrency exchange, etc.

Within some embodiments of the invention described so far, the Retros are acquired by the user through an activity with a retailer, service provider etc. However, in other embodiments of the invention an OEM, for example, as part of a consumer reward may directly load Retros into a participating RetroWallet owner's wallet. For example, PepsiCo could send a Retro to a participating RetroWallet owner allowing the RetroWallet owner to obtain a Pepsi™ drink free from a participating vendor. Accordingly, the Retro is issued with characteristics, benefits, rights, obligations, and limitations where the Retro is effectively “valued” at price of the Pepsi™ drink set by PepsiCo and is specific to PepsiCo. Optionally, within another embodiment of the invention then PepsiCo may provide the vendor with a vendor specific Retro in exchange for the PepsiCo specific Retro that they acquired from each user. The vendor can then employ the vendor specific Retros as a reward to its customers so that the vendor is incentivized to partake in the promotion PepsiCo offers to customers.

Within embodiments of the invention a software application, referred to as RetroPoints software, permits a RetroWallet owner to view their Retros, examine transactions on the RetroWallet owner's RetroChain, etc.

It would be evident that initially in order to incent customers to the concept of Retros then “white” Retros without characteristics, benefits, rights, obligations, and limitations may initially be used to purchase specific discounted products for Retros or Retros and another currency. Concurrently, a limited number of “coloured” Retros would be initially issued, subject to agreements with commercial entities in place at the time of initial release. Subsequently, as Retros become more common, the introduction of additional “coloured” Retros would be expected. This approach may also be used by each vendor who joins the Retro rewards scheme.

Within other embodiments of the invention:
Retros may be provided by enterprises for referrals;
Retros may be provided to RetroWallet owners allowing them to purchase a free or discounted ticket for an event;
Retros may be provided to Consumers and Employees with RetroWallets for meeting milestones;
Retros may be provided to RetroWallet owners as prelaunch offers to drive traffic and peak interest;
Retros may be provided to First Time Customers; and
Retros may be provided for customer membership incentives.

Within the overall infrastructure and architecture for Retros then a software development kit (SDK) may be established which allows third-parties to sell loyalty and rewards software and points programs that use Retros instead of “points” in their loyalty and rewards software.

The Retro token exploits methodologies established by the inventor with respect to identity security, a concept referred to as RetroIdentity or RetroID. These concepts are presented within the following U.S. Patent Applications which are incorporated herein, in their entirety, by reference:
U.S. patent application Ser. No. 15/613,252 entitled “Portable Verifiable Credentials and Methods Thereof”, filed Jun. 4, 2017;
U.S. patent application Ser. No. 15/613,253 entitled “Verifiable Identity Attributes and Credentials for Real-World Financial Transactions”, filed Jun. 4, 2017;
U.S. patent application Ser. No. 15/044,055 entitled “Portable Verifiable Credentials and Methods Thereof”, filed Feb. 15, 2016;
U.S. patent application Ser. No. 14/453,901 entitled “Verification Authority and Method Therefor”, filed Aug. 7, 2014;
U.S. patent application Ser. No. 14/630,728 entitled “Systems and Methods Relating to the Authenticity and Verification of Photographic Identity Documents”, filed Feb. 25, 2015;
U.S. patent application Ser. No. 14/672,884 entitled “Methods and Systems Relating to Real World and Virtual World Identities”, filed Mar. 30, 2015;
U.S. patent application Ser. No. 14/958,267 entitled “Verifiable Credentials and Methods Thereof”, filed Dec. 3, 2015
U.S. patent application Ser. No. 14/688,918 entitled “Methods and Systems Relating to Real World Document Verification”, filed Apr. 16, 2015.

Accordingly, a user can establish a RetroID which refers to a third party verified identity or self-sovereign identity etc., which has been validated back to one or more Government issued photographic identities exploiting the technique and methods described and depicted within these patent applications. Accordingly, a user can establish a RetroWallet either with or without a RetroID but exploiting a RetroID allows the user to subsequently perform transactions where their identity is verifiable. Accordingly, Retros can be also associated with the RetroID if the user wishes. A RetroID may also be validated by non-Government identity data stores such as those as associated with banks, credit card companies, telecom service providers, postal outlets, municipalities, car rental agencies, virtual gaming (Government run, and non-Government run), etc.

Accordingly, a Retro token can provide the user with a cryptographically defined currency discretely or in combination with securely delivering identity as part of a transaction. Equally, in reverse the RetroID and its associated infrastructure and validated identity allows the user to provide this discretely or in combination with delivery value. Within embodiments of the invention described and depicted within the above referenced patent applications retailers may deploy what are referred to as “Retro360 Terminals” which allow the customer to perform a transaction at the retailer but in a manner wherein the identity of the customer with respect to the financial instrument being employed can be verified either discretely or in combination with establish one or more other proofs such as age, for age restricted purchases, residency (for transactions restricted to residents of specific states, countries etc. or only non-residents etc.), legal entitlement (to receive legislated drugs such as narcotics, pharmaceuticals, etc.), etc. Accordingly, where embodiments of the invention described within the above referenced patents may have been with respect to prior art physical and electronic financial instruments such as credit cards, debit cards, credit card applications, debit card applications, and “tap-and-go” NFC or RFID based electronic transactions the Retro and the RetroWallet allow for the transactions to exploit one or more cryptocurrencies.

Accordingly, users may exploit the Retro in combination with RetroID thereby providing the token holder with the ability to use the Retro360 Terminal and/or in-store or online applications integrated or linked with their RetroWallet for transactions that require identity assurance and proof/validation of other aspect of the user such as age, residency, legal entitlement etc.

Accounting of the Retro is handled by the RetroID distributed ledger known as a RetroChain, which tracks all transactions involving Retros. This includes transactions that represent presentation and/or verification of identity indicators and rewards, as well as all transactions that transfer ownership of Retros from one user to another, e.g. from one RetroWallet to RetroWallet or another electronic cryptographic currency store/wallet. For mobile identification the transfer of rewards is achieved by transferring one or more Grains/Retros from one RetroWallet to another. Whilst a RetroWallet for a consumer may be typically anticipated as performing a single transaction at a time such as payment or receipt, a RetroWallet for a vendor may be configured differently so that the Vendor's RetroWallet can simultaneously receive and transmit with respect to multiple transactions concurrently. Alternatively, a vendor may exploit RetroWallet's much like traditional cash registers such that they are isolated, and each receives/transmits to another RetroWallet so that a store may have point-of-sale (POS) specific RetroWallets that communicate to a “store” RetroWallet at a higher level, etc. so that a vendor may have a hierarchy of RetroWallets.

Within embodiments of the invention Retros are not mined or minted continuously within its economy in contrast to other cryptographic currency based economies. In these embodiments a fixed number of tokens (Retros) are created, and RetroID will not create additional Retros in the future and these Retros may be tradeable on one or more cryptocurrency exchanges. Alternatively, Retros may be managed in a similar manner to a so-called “fiat currency” by a centralized authority that manages the number of Retros overall and the value of the Retro is derived from the relationship between supply and demand. A “fiat currency” is known in the prior art as one that is not backed by a physical commodity.

As noted above the Retro by virtue of comprising information relating to the holder of the Retro is Identity Vehicle. Every time a RetroWallet is employed either discretely or in combination with a Retro360 terminal, for in-store photographic identity (Photo-ID) validation, age verification etc. or to validate or assert one or more rewards, a Retro transaction is recorded on the RetroChain Distributed Ledger, e.g. blockchain ledger (RetroChain).

Referring to FIG. 1 there is depicted a schematic of a Retro enabled network (RetroNetwork) and exemplary transaction flows relating to rewards and incentives according to an embodiment of the invention. Accordingly, FIG. 1 depicts different parties who send and receive Retros in various identity transactions defined within the RetroNetwork. The parties depicted being:
Customer 310 with RetroWallet 315;
RetroID or associated partner 320;
Remote ID Authenticator 330;
“Bricks and Mortar” (Physical) vendor or service provider 340 with Retro360 terminals 345; and
Online vendor or service provider 350.

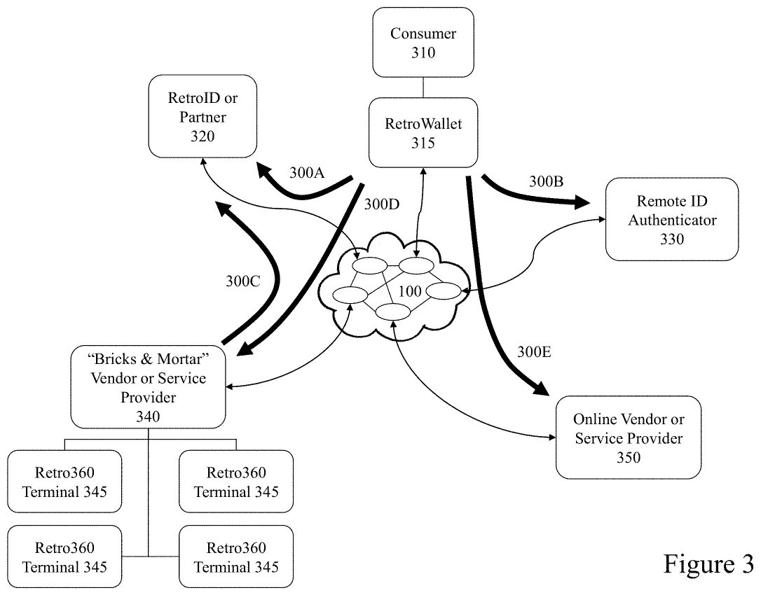

Accordingly, different transaction types are possible between these parties of which five are identified in FIG. 3 by the first to fifth process arrows 300A to 300E respectively. The transaction types identified by the number arrows in the diagram include the following:
First process 300A between the customer's RetroWallet 315 with a self-sovereign identity service, e.g. RetroID or Partner 320;
Second process 300B between the customer's RetroWallet 315 and a remote identity proofing application hosted by Remote ID Authenticator 330;
Third process 300C wherein in-person assurance that a Photo-ID holder is the person to whom the Photo-ID was lawfully issued is undertaken between Bricks and Mortar Vendor or Service Provider 340 and a self-sovereign identity service, e.g. RetroID or Partner 320;
Fourth process 300D wherein the customer provides via their RetroWallet 315 one or more portable Photo-ID credentials to the Bricks and Mortar Vendor or Service Provider 340; and
Fifth process 300E wherein the customer provides via their RetroWallet 315 one or more portable Photo-ID credentials to an online vendor or service provider 350.

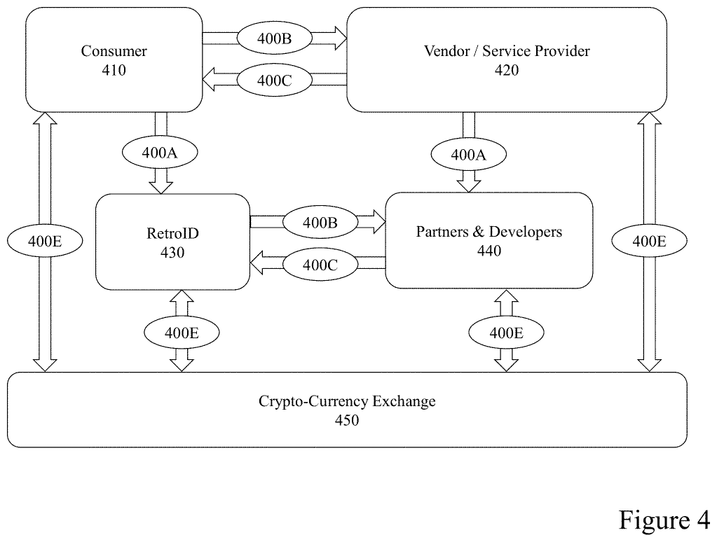

Accordingly, the Retro can be employed for both identity delivery and financial transactions. As indicated in FIG. 4 Retros can deliver value throughout a digital cryptographically based economy depicting exemplary transaction flows relating to the digital cryptographically based economy exploiting rewards and incentives according to an embodiment of the invention. Accordingly, there are depicted:
Consumer 410;
Vendor/Service Provider 420;
RetroID 430;
Partners and Developers 440; and
Cryptocurrency Exchange 450.

Accordingly, within FIG. 4 there are depicted exemplary pathways between these parties within the Retro Economy where the Retro can deliver value concurrently with identity. These being:
First pathways 400A relating to the payment of licensing, subscription, and transaction fees;
Second pathways 400B relating to payments for goods and services;
Third pathways 400C relating to consumer Loyalty Rewards programs;
Fourth pathways 400D relating to Community Developer programs; and
Fifth pathways 400E relating to buying and selling Retros.

Payment of Subscription and Transaction Fees

Within embodiments of the invention the RetroWallet is designed to provide its owner not only with identity security and control over their personal identifiable information, but also with convenience when it comes to interacting with identity (ID) requestors. Accordingly, whilst RetroID is primarily described and depicted with respect to applications upon PEDs an alternative embodiment exploits a FED based version of the RetroWallet available via one or more websites. The PED RetroWallet software application would be accessible through typical mobile device applications stores such as those operated by PED providers such as Apple™, Microsoft™, Google™, and Fitbit™ for example.

With an embodiment of the invention a user may exploit a free download and establish a basic RetroWallet account (Basic Account) and uses the RetroWallet to acquire Retros, make Retro based purchases and exploit Retro trading capabilities within the RetroNetwork. A RetroWallet owner can subsequently or initially subscribe to an “Elite Account” allowing them to use the RetroWallet's identification capabilities through RetroID and exploit applications that require identity assurance and authentication over the RetroNetwork. Consumer subscription fees associated with the “Elite Account” being payable by the consumer to the operator of RetroID in Retros.

Within embodiments of the invention a RetroWallet with an expired subscription will continue to have the limited functionality of a Basic Account. The RetroWallet owner will be able to access and manage Retros stored in the RetroWallet application upon their PED or FED or exploit a physical digital wallet (what the inventor refers to as a hard wallet), and undertake the buying and selling Retros and other cryptocurrencies will be permitted, for example.

Within embodiments of the invention brick and mortar vendors and service providers that install Retro360 Terminals may pay a subscription fee, and where applicable, transaction fees in Retros to the provider of the RetroID service which may be a country partner of RetroID, RetroID itself, or a licensee of RetroID. A limit or “cap” on per-transaction fees may allow participating vendors to better understand and predict the costs of participating in the Retro Economy. This is especially important to vendors in market segments where margins are small. Within other embodiments of the invention partners may be able to establish their own pricing models. Within embodiments of the invention a small percentage of the revenues garnered by each partner will flow through to RetroID where terms of these payments will be set down in the licensing agreements executed with each of the partners.

Payments for Goods and Services

Beneficially vendors exploiting Retros as payment and require identity assurance would be able to generate a Retro transaction that carries with it the proof that identity was established, verified and accepted. Within embodiments of the invention in order to increase the uptake of vendors to the novel digital cryptocurrency RetroID may issue incentives to vendors to accept Retros as payment to increase convenience for RetroWallets owners.

Such transactions may be established, accomplished, performed, etc. with RetroPay, Apple Pay, Mastercard Masterpass, Samsung Pay, etc. or other financial transaction systems, providers etc. Optionally, such financial transaction providers may provide a small fee or percentage of the transaction to the “wallet” owner, e.g. RetroPay, or the vendors may provide a small fee or percentage.

Consumer Loyalty Reward Program

Within embodiments of the invention a mechanism for supporting the use of Retros for identification and purchases is the Consumer Loyalty Reward Program. This program is a means for vendors in both the brick and mortar physical retailing and the online retailing worlds to encourage consumers to use a self-sovereign identity and RetroWallet to complete identity-assured transactions. Accordingly, RetroID provides consumers with a convenience via the electronic RetroWallet which is superior to the “real world” process of having to produce a physical driver's license every time they wish to rent a hotel room, open a bank account, purchase a pack of cigarettes or a six-pack of beer, etc. The user's identity is digitally secure and provided as part of the transaction. A Consumer Loyalty Reward Program through multiple vendors makes the RetroWallet even more attractive by giving the Consumer a chance to acquire rewards, get Retros, when conducting transactions within the same process as making the transaction. Today, even if a user has an electronic version of their reward card on their smartphone and exploits an NFC payment process on their smartphone the identification of the user's reward card is a separate process to that of payment.

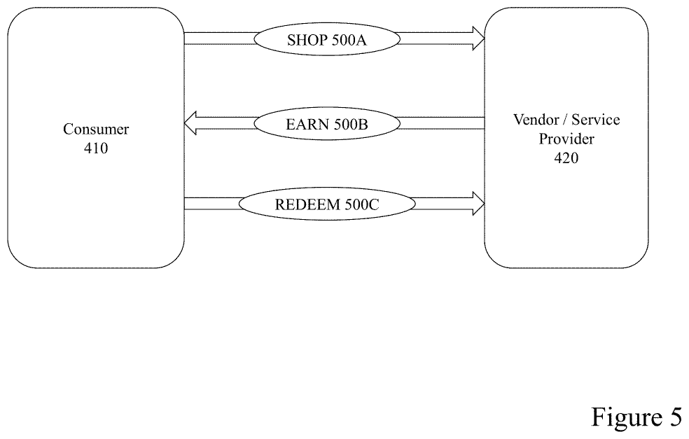

Referring to FIG. 5 there is depicted an exemplary rewards and incentive program between a customer and a vendor/service provider exploiting rewards and incentives according to embodiments of the invention. Accordingly, there are depicted a consumer 410 and a vendor/service provider 420 wherein three different processes are depicted:
First process 500A relating to the consumer 410 shopping with the vendor/service provider 420, i.e. undertaking a transaction to purchase a product(s) and/or service(s);
Second process 500B relating to the consumer 410 earning a reward with the vendor/service provider 420, i.e. a reward established through their performing first process 500A; and
Third process 500C relating to the consumer 410 redeeming the reward with the vendor/service provider 420, this being the reward earned for example in step 500B.

Accordingly, first process 500A relates to a RetroWallet owner shopping at a participating vendor's location. One or more identity indicators are required by an ID-requestor for a transaction that requires an identity check. The requested information is delivered by way of the RetroWallet of the Consumer 410, and the ID-requestor sends a reward in Retros from their RetroWallet to the Consumer's RetroWallet.

Second process 500B relates to the RetroWallet owner earning rewards from the vendor for making a purchase. The purchase price may be paid in a flat currency or in Retros if the vendor supports payments in Retros or one or other cryptocurrencies. Based on the value of the purchase, the vendor delivers a pre-defined loyalty reward, paid in Retros, to the RetroWallet of the Consumer 410. This may be a fixed quantity of Retros, or may be a percentage of the sale.

Subsequently, in third process 500C the Consumer 410 can redeem Retros to obtain select goods or services from participating vendors. The Consumer 410 can use Retros to make purchases from a participating vendor, e.g. Vendor/Service Provider 420. These transactions may or may not themselves require transfer of identity indicators, depending on the nature of the products.

Accordingly, a Loyalty Rewards program may be designed to promote the use of Retros as a loyalty and reward currency. This may be particularly beneficial where the vendor requires reliable ID credentials to complete a transaction as they benefit by having the assurance of relying upon the Consumer's Self-Sovereign Identity. Consumers are enticed to participate by the promise of rewards paid in Retros (much like a “cash-back” or “points” reward system. Finally, businesses that offer the opportunity to obtain goods or services in exchange for Retros can distinguish themselves from competition that does not offer a reward program, thus increasing customer base and market share.

In addition to marketing Loyalty Reward Programs to retail vendors, where regulations allow, RetroID can also be targeted at\the producers of goods or services that require identity information for legal purchases. Examples of such purchases may include, but are not limited to, alcoholic beverages, tobacco products, pharmaceuticals, medicinal narcotics, firearms and ammunition. Such programs can be thought of in the same manner as a “Manufacturer Coupon” program.

Within embodiments of the invention Loyalty Rewards Programs, whether based on particular retail establishments or widely-available products, will be designed to provide Vendors and Suppliers with a way to reward Consumers for using a RetroWallet by employing a quantity of Retros that have been specially customized to restrict their usage only to their particular reward program. The Vendor or Supplier will have the ability to re-convert customized Retros into generic ones, enabling them to manage value represented by their Rewards Programs.

Within embodiments of the invention a vendor-based Loyalty Rewards Program can be managed by RetroID, a RetroID country partner, a RetroID licensees or may be tailored to specific geographic regions, market segments, or individual vendors. Such programs can even be customized to determine where the reward Retros will come from. In some applications sales margins may be too small for a vendor to support such a program profitably, the Partner may decide to outsource the Retros paid back to Consumers. The partner may see this to encourage more widespread adoption of RetroWallets by Consumers.

The Retro Economy does not stop with vendors and service providers in the retail, educational, medical, and government service sectors, and it is not limited to RetroID partners. Third-party developers may be incentivized to develop new applications that operate within the Retro Economy and leverage the power and security of Self-Sovereign Identity of the individual consumer.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method for providing one or more digital reward tokens as a component of an online virtual transaction between a first party and a second party, comprising:
a. First party employs a first electronic device, which may be one of a handheld “smart” telephonic device; a portable or handheld “tablet” computing device; a portable “laptop” device; or a “desktop computing” device to send first data to a first server under the control of a second party, which may be a computer system connected to the internet, and owned, operated, or managed by the second party for purposes including the conducting online commerce; or a computer system connected to the internet, and owned, operated, or managed by a third party for purposes including the support of online commerce involving the second party. whereby the first party gains access to the ability to purchase goods or services from the second party; and
b. First party selects desired goods or services; and
c. First party and second party exchange digital information necessary to complete the transaction, including payment method and financial identity details, shipping information, and any other information deemed necessary by either party; and
d. Second party sends second data to the first electronic device whereby the second party delivers one or more digital tokens representing a reward for completing the transaction; said tokens then being stored within the first electronic device.

2. A method according to claim 0 wherein the first data consists of at least one of:
a. A set of digital credentials satisfactory to the second party to identify the first party as a valid participant in a rewards program offered by the second party; or
b. A set of digital credentials satisfactory to the second party to register the first part as a new valid participant in a rewards program offered by the second party.

3. A method according to claim 0 wherein the desired goods for purchase consist of at least one of the following:
a. Any goods or services routinely offered by the second party for purchase; or
b. One or more digital tokens representing a fixed value denominated in a commonly acceptable currency or legal tender, but which may be restricted for use only in purchasing future goods or services from the second party or designated associates of the second party; or
c. One or more digital tokens representing the ability to obtain future goods or services on one or more occasions at a cost discounted relative to the prevailing market rate; or
d. One or more digital tokens representing the ability to obtain future goods or services on one or more occasions without compensation other than the surrender of the token or tokens.

4. A method according to claim 0 wherein the medium of payment for goods and services includes at least one of:
a. A mutually agreeable common currency, deliverable via commonly used digital transaction methods such as a credit card held by the first party, a debit card held by the first party, or bank account information sufficient to authorize direct transfer of common currency; or
b. A mutually agreeable digital currency (cryptocurrency), deliverable via commonly used digital transaction methods appropriate to the digital currency; or
c. One or more digital tokens originally delivered to the first party during prior transactions between first party and second party under the terms of a reward program, and now delivered back to the second party by the first party.

5. A method according to claim 0 wherein the rewards program offers rewards for at least one of the following behaviors on the part of the first party:
a. The purchase of specific goods or services; or
b. The purchase of goods or services whose value reaches a threshold designated by terms of the rewards program; or
c. The use of an identity presentation protocol recognized by the second party as being sufficiently secure as to reduce opportunity for fraud; or
d. The use of a payment delivery or processing protocol recognized by the second party as being sufficiently secure as to reduce opportunity for fraud.

6. A method according to claim 0 wherein the reward delivered via digital tokens in second data consists of at least one of:
a. One or more digital tokens representing a fixed value denominated in a commonly acceptable currency or legal tender; or
b. One or more digital tokens representing a variable value denominated in a commonly acceptable currency or legal tender; or
c. One or more digital tokens representing a commitment for the second party to provide an additional specified good or service in the future in return for compensation at a rate discounted relative to the prevailing market rate; or
d. One or more digital tokens representing a commitment for the second party to provide an additional specified good or service in the future without compensation other than the surrender of the token or tokens.

7. A method according to claim 0 wherein a digital record of the transaction is recorded on a digital ledger consisting of at least one of:
a. A distributed public ledger employing blockchain or similar technology to ensure immutability;
b. A data store maintained by one or more entities (private or consortium) that ensures immutability by employing at least one of:
i. blockchain technology;
ii. limitations to network availability (i.e. air-gap)

8. A method for providing one or more digital reward tokens as a component of a transaction conducted in person between a first part and a second party at a physical location operated by the second party, comprising:
a. First party selects desired goods or services available at the physical location; and
b. First party employs a first electronic device, which may be a handheld “smart” telephonic device, a portable or handheld “tablet” computing device; or a portable “laptop” device to send first data to a second electronic device under the control of a second party whereby the first party identifies itself as a participant in a rewards program offered by the second party; and
c. First party and second party complete the transaction details involving payment for the selected goods or services; and
d. Second party sends second data to the first electronic device whereby the second party delivers one or more digital tokens representing a reward for completing the transaction; said tokens then being stored within the first electronic device.

9. A method according to claim 8 wherein the second electronic device consists of at least one of:
a. A point-of-sale terminal capable of communicating with the first electronic device; or
b. An electronic device connected to second party's commerce systems capable of communicating with the first electronic device; or
c. An electronic device connected to second party's commerce systems capable of capturing an image displayed on the first electronic device.

10. A method according to claim 8 wherein the first data consists of at least one of:
a. A set of digital credentials satisfactory to the second party to identify the first party as a valid participant in a rewards program offered by the second party; or
b. A set of digital credentials satisfactory to the second party to register the first part as a new valid participant in a rewards program offered by the second party.

11. A method according to claim 8 wherein the desired goods for purchase consist of at least one of the following:
a. Any goods or services routinely offered by the second party for purchase; or
b. One or more digital tokens representing a fixed value denominated in a commonly acceptable currency or legal tender, but which may be restricted for use only in purchasing future goods or services from the second party or designated associates of the second party; or
c. One or more digital tokens representing the ability to obtain future goods or services on one or more occasions at a cost discounted relative to the prevailing market rate; or
d. One or more digital tokens representing the ability to obtain future goods or services on one or more occasions without compensation other than the surrender of the token or tokens; or
e. A physical card representing digital tokens which in turn represent a fixed value denominated in a commonly acceptable currency or legal tender, but which may be restricted for use only in purchasing future goods or services from the second party or designated associates of the second party, and which contains a unique identifier such as, but not limited to, a serial number, a one-dimensional or matric bar-code representation of a unique alphanumeric sequence, a fractal or other mathematically derived image, a magnetically recorded unique identifier, or a digital chip component capable of delivering the unique identifier to a properly equipped receiving device, which when combined with evidence of payment and validated identification credentials authorizes the transfer of said digital tokens from the second party to the first party; or
f. A physical card representing digital tokens which in turn represent the ability to obtain future goods or services on one or more occasions at a cost discounted relative to the prevailing market rate, and which contains a unique identifier such as, but not limited to, a serial number, a one-dimensional or matric bar-code representation of a unique alphanumeric sequence, a fractal or other mathematically derived image, a magnetically recorded unique identifier, or a digital chip component capable of delivering the unique identifier to a properly equipped receiving device, which when combined with evidence of payment and validated identification credentials authorizes the transfer of said digital tokens from the second party to the first party; or
g. A physical card representing digital tokens which in turn represent the ability to obtain future goods or services on one or more occasions without compensation other than the surrender of the token or tokens, and which contains a unique identifier such as, but not limited to, a serial number, a one-dimensional or matric bar-code representation of a unique alphanumeric sequence, a fractal or other mathematically derived image, a magnetically recorded unique identifier, or a digital chip component capable of delivering the unique identifier to a properly equipped receiving device, which when combined with evidence of payment and validated identification credentials authorizes the transfer of said digital tokens from the second party to the first party.

12. A method according to claim 8 wherein the rewards program offers rewards for at least one of the following behaviors on the part of the first party:
a. The purchase of specific goods or services; or
b. The purchase of goods or services whose value reaches a threshold designated by terms of the rewards program; or
c. The use of an identity presentation protocol recognized by the second party as being sufficiently secure as to reduce opportunity for fraud; or
d. The use of a payment delivery or processing protocol recognized by the second party as being sufficiently secure as to reduce opportunity for fraud.

13. A method according to claim 8 wherein the reward delivered via digital tokens in second data consists of at least one of:
a. One or more digital tokens representing a fixed value denominated in a commonly acceptable currency or legal tender; or
b. One or more digital tokens representing a variable value denominated in a commonly acceptable currency or legal tender; or
c. One or more digital tokens representing a commitment for the second party to provide an additional specified good or service in the future in return for compensation at a rate discounted relative to the prevailing market rate; or
d. One or more digital tokens representing a commitment for the second party to provide an additional specified good or service in the future without compensation other than the surrender of the token or tokens.

14. A method according to claim 8 wherein a digital record of the transaction is recorded on a digital ledger consisting of at least one of:
a. A distributed public ledger employing blockchain or similar technology to ensure immutability;
b. A data store maintained by one or more entities (private or consortium) that ensures immutability by employing at least one of:
i. blockchain technology;
ii. limitations to network availability (i.e. air-gap)

15. A method for providing one or more digital reward tokens as a component of an online virtual transaction between a first party and a second party, comprising:
a. First party employs a first electronic device, which may be one of a handheld “smart” telephonic device; a portable or handheld “tablet” computing device; a portable “laptop” device; or a “desktop computing” device to send first data to a first server under the control of a second party, which may be a computer system connected to the internet, and owned, operated, or managed by the second party for purposes including the conducting online commerce; or a computer system connected to the internet, and owned, operated, or managed by a third party for purposes including the support of online commerce involving the second party.
b. whereby the first party gains access to the ability to purchase goods or services from the second party; and
c. First party sends second data to the first server providing proof of prior purchase of eligible goods or services, said proof being in accordance with second party's requirements; and
d. Second party sends second data to the first electronic device whereby the second party delivers one or more digital tokens representing a reward for purchasing the goods or services; said tokens being stored within the first electronic device.

16. A method according to claim 15 wherein the first data consists of at least one of:
a. A set of digital credentials satisfactory to the second party to identify the first party as a valid participant in a rewards program offered by the second party; or
b. A set of digital credentials satisfactory to the second party to register the first part as a new valid participant in a rewards program offered by the second party.

17. A method according to claim 0 wherein the reward delivered via digital tokens in second data consists of at least one of:
a. One or more digital tokens representing a fixed value denominated in a commonly acceptable currency or legal tender; or
b. One or more digital tokens representing a commitment for the second party to provide an additional specified good or service in the future in return for compensation at a rate discounted relative to the prevailing market rate; or
c. One or more digital tokens representing a commitment for the second party to provide an additional specified good or service in the future without compensation other than the surrender of the token or tokens.

18. A method according to claim 0 wherein a digital record of the transaction is recorded on a digital ledger consisting of at least one of:
a. A distributed public ledger employing blockchain or similar technology to ensure immutability;
b. A data store maintained by one or more entities (private or consortium) that ensures immutability by employing at least one of:
i. blockchain technology;
ii. limitations to network availability (i.e. air-gap)
